(19) United States
(12) Patent Application Publication
(10) Pub. No.: US 2018/0072161 A1
(43) Pub. Date: Mar. 15, 2018

(54) ELECTRIC WHEELCHAIR, CONTROL METHOD THEREOF AND CONTROL SYSTEM THEREOF

(71) Applicant: INDUSTRIAL TECHNOLOGY RESEARCH INSTITUTE, Hsinchu (TW)

(72) Inventors: Li-Zen Lin, Taipei City (TW); Pin-Yung Chen, Hsinchu City (TW); Yi-Ling Lin, Taichung City (TW); Chin-Chang Chen, Hsinchu City (TW)

(21) Appl. No.: 15/388,348

(22) Filed: Dec. 22, 2016

Related U.S. Application Data
(60) Provisional application No. 62/385,922, filed on Sep. 9, 2016.

(30) Foreign Application Priority Data
Dec. 20, 2016 (TW) 105142265

(51) Int. Cl. B60L 3/12; A61G 5/04; G05D 1/00; B60L 15/20; B60L 15/40

(52) U.S. Cl. CPC B60L 3/12; A61G 5/04; A61G 2203/12; B60L 15/20; B60L 15/40; G05D 1/0016

(57) ABSTRACT

An electric wheelchair, a control method thereof and a control system thereof are provided. The control method includes the following steps. Firstly, a control signal is outputted to the electric wheelchair by way of wireless according to a posture of a handheld controller. Then, the electric wheelchair performs a corresponding motion according to the control signal.

### CROSS-REFERENCE TO RELATED APPLICATION

This application claims the benefit of US provisional application Ser. No. 62/385,922, filed Sep. 9, 2016, the subject matter of which is incorporated herein by reference, and claims the benefit of Taiwan application Serial No. 105142265, filed Dec. 20, 2016, the subject matter of which is incorporated herein by reference.

### TECHNICAL FIELD

The technical field relates to an electric wheelchair, a control method thereof and a control system thereof, and more particularly to an electric wheelchair capable of performing a motion according to a posture of a handheld control device, a control method thereof and a control system thereof.

### BACKGROUND

For conventional wheelchair, a rider himself needs to operate the wheel for making the wheelchair to go forward, back or make a turn. Alternatively, another person pushes the wheelchair on its back to make the wheelchair to go forward, back or make a turn. In order to care for disabled patients, some conventional wheelchair may be operated by a joystick. However, such way is still not very convenient for certain patients suffering from, for example, muscular dystrophy.

In addition, conventional electric wheelchair controls the speed and directions of the right wheel and the left wheel by one controller, and the left wheel and the right wheel can't be individually controlled.

### SUMMARY OF THE DISCLOSURE

According to an embodiment of the disclosure, a control method for an electric wheelchair is provided. The control method includes the following steps. A plurality of control signals is outputted to a plurality of driving to devices of the electric wheelchair respectively by way of wireless technologies according to a posture of a handheld controller, wherein the number of the control signals is equal to the number of the driving devices; the electric wheelchair is controlled to perform a corresponding motion by the driving device of the electric wheelchair in accordance with the control signals; whether the handheld controller is at an abnormal state is detected; and if the handheld controller is at the abnormal state, temporarily stopping outputting the control signal to the electric wheelchair.

According to another embodiment of the disclosure, a control system for an electric wheelchair is provided. The control system includes a handheld controller and an electric wheelchair. The handheld controller includes an acceleration sensor and a controller. The acceleration sensor is configured to output a corresponding acceleration information according to a posture of the handheld controller. The controller is configured to output a plurality of control signals according to the acceleration information. The electric wheelchair includes a wheelchair body and a plurality of driving devices. The wheelchair body includes a plurality of wheels. Each of the driving devices is configured to detachably dispose on the wheels of the wheelchair body for controlling the wheels to rotate according to the control signals respectively to perform a corresponding motion, wherein the number of the control signals, the number of the driving devices and the number of the wheels are equal. The handheld controller is further configured to: detect whether the handheld controller is at an abnormal state according to the acceleration information; and if the handheld controller is at the abnormal state, respectively output a plurality of stop operation signals to the driving devices and then stop outputting the control signal to the electric wheelchair.

According to another embodiment of the disclosure, an electric wheelchair is provided. The electric wheelchair includes a wheelchair body and a plurality of driving devices. The wheelchair body includes a plurality of wheels. Each of the driving devices is detachably disposed on the wheels of the wheelchair body. The driving devices are configured to control the wheelchair body to perform a corresponding motion according to a plurality of control signals from a handheld controller, and the control signals are determined by a posture of the handheld controller; wherein the number of the control signals, the number of the driving devices and the number of the wheels are equal, and the driving devices are configured to, in response to a plurality of stop operation signals, stop driving the wheels.

The above and other aspects of the present disclosure will become better understood with regard to the following detailed description of the preferred but non-limiting embodiment (s). The following description is made with reference to the accompanying drawings.

### BRIEF DESCRIPTION OF THE DRAWINGS

FIG. 1 illustrates a diagram of a control system according to an embodiment of the present disclosure;

FIG. 2 illustrates a diagram of functional blocks of the right driving device of the handheld controller of FIG. 1;

FIG. 3 illustrates a flowchart of a control method for the electric wheelchair according to an embodiment of the present disclosure;

FIGS. 4A-4C illustrate diagrams of several control methods of the present embodiment according to the present disclosure;

FIGS. 5A-5D illustrate diagrams of several control methods of the present embodiment according to the present disclosure;

FIG. 6 illustrates a flowchart of detecting whether the handheld controller is at the abnormal state according to an embodiment of the present disclosure; and

FIG. 7 illustrates a diagram of an array of the average value of accelerations according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION OF DISCLOSED EMBODIMENTS

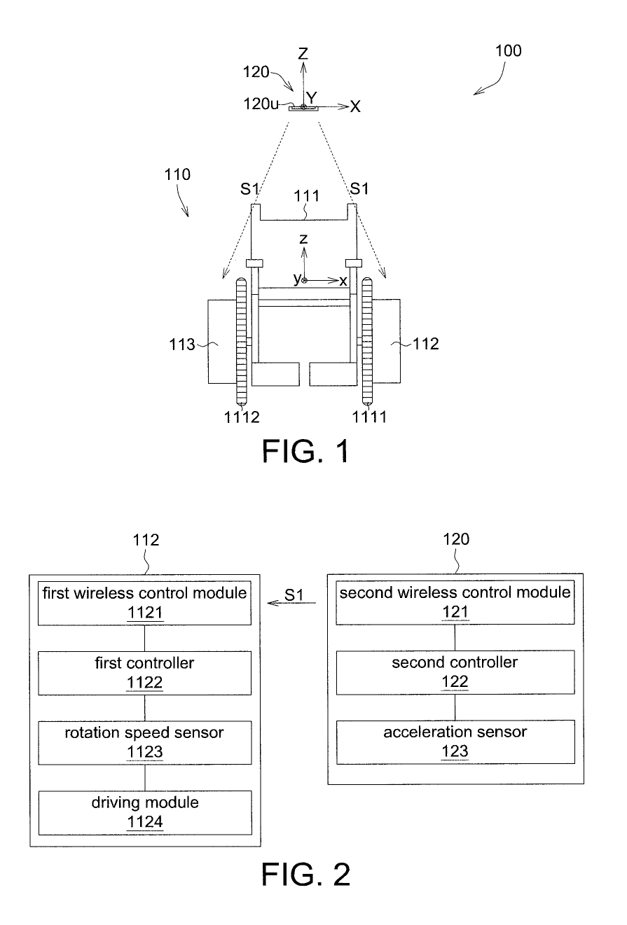

FIG. 1 illustrates a diagram of a control system 100 according to an embodiment of the present disclosure. The control system 100 includes an electric wheelchair 110 and a handheld controller 120. The handheld controller 120 may control the electric wheelchair 110 to perform different motions according to a posture of the handheld controller 120. For example, the handheld controller 120 has an X axis, a Y axis and a Z axis which are vertical to each other. The aforementioned posture is how the handheld controller 120 rotates around at least one of the X axis, the Y axis and the Z axis. In an embodiment, the operator (such as a patient) of the handheld controller 120 may sit on a wheelchair body 111 to operate the electric wheelchair 110; however, such exemplification is not meant to be limiting. An operator also may operate the electric wheelchair 110 outside the electric wheelchair 110.

The electric wheelchair 110 includes the wheelchair body 111 and a plurality of driving devices, such as a right driving device 112 and a left driving device 113. The type of the wheelchair according to the present disclosure is not limited to the present embodiment, and it can be any kind of wheelchairs. The wheelchair body 111 includes a plurality of wheels, such as a right wheel 1111 and a left wheel 1112. The right driving device 112 and the left driving device 113 are detachably disposed on the right wheel 1111 and the left wheel 1112 respectively for driving the right wheel 1111 and the left wheel 1112 to rotate. The right driving device 112 and the left driving device 113 may control the rotational speeds of the right wheel 1111 and the left wheel 1112 for controlling the motion speed and changing the direction of the wheelchair body 111. In another embodiment, the number of the wheels of the wheelchair body 111 may be one or more than two, for example, three or even more. The number of the driving devices may be equal to the number of the wheels.

For example, the right driving device 112 and the left driving device 113 may control the rotational speed of the right wheel 1111 to be different from the rotational speed of the left wheel 1112 for controlling the wheelchair body 111 to make a turn. For example, when the rotational speed of the left wheel 1112 is controlled to be faster than the rotational speed of the right wheel 1111, the wheelchair body 111 may turn right in place or turn right while advancing. Alternatively, when the rotational speed of the right wheel 1111 is controlled to be faster than the rotational speed of the left wheel 1112, the wheelchair body 111 may turn left in place or turn left while advancing. However, such exemplification is not meant to be limiting. The wheelchair body 111 may perform other various motions through controlling the rotational speed of the right wheel 1111 and the rotational speed of the left wheel 1112.

FIG. 2 illustrates a diagram of functional blocks of the right driving device 112 of the handheld controller 120 of FIG. 1. The right driving device 112 includes a first wireless control module 1121, a first controller 1122, a rotational speed sensor 1123 and a driving module 1124. The first wireless control module 1121 is a wireless module using, for example, Bluetooth, radio frequency identification (RFID), WiFi, Near Field Communication (NFC), Long Term Evolution (LTE), etc. The rotational speed sensor 1123 may sense the rotational speed of the right wheel 1111 or calculate the rotational speed of the right wheel 1111 according to the rotational speed of a driving shaft of the driving module 1124. The rotational speed sensed or calculated by the rotational speed sensor 1123 may be transmitted to the handheld controller 120 through the first wireless control module 1121 and may display on a display surface 120u of the handheld controller 120. The first controller 1122 is configured to control the driving module 1124 to drive the right wheel 1111 to rotate. The left driving device 113 has structures similar to that of the right driving device 112, and the similarities are not repeated here. As long as the handheld controller 120 can receive the control signals S1 and drive the right wheel 1111 and the left wheel 1112 of the wheelchair body 111 to rotate, the structures of the left driving device 113 and the right driving device 112 are not limited to the present embodiment.

As shown in FIG. 2, the handheld controller 120 includes a second wireless control module 121, a second controller 122 and an acceleration sensor 123. The control signal S1 of the handheld controller 120 is transmitted to the first wireless control module 1121 of the right driving device 112 and the first wireless control module of the left driving device 113 through the second wireless control module 121. The second wireless control module 121 is a wireless module using, for example, Bluetooth, RFID, WiFi, NFC, LTE, etc., such that the handheld controller 120 may communicate with the right driving device 112 and the left driving device 113 of the electric wheelchair 110 through the second wireless control module 121 by way of aforementioned wireless technologies.

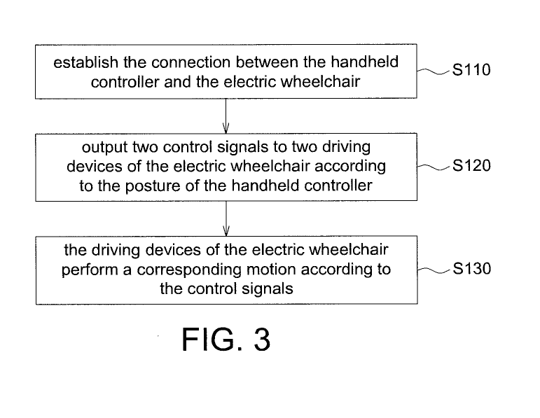

FIG. 3 illustrates a flowchart of a control method for the electric wheelchair according to an embodiment of the present disclosure.

In the step S110, a connection between the handheld controller 120 and the electric wheelchair 110 is established. For example, in using Bluetooth technology, the handheld controller 120 may be paired with the right driving device 112 and the left driving device 113 of the electric wheelchair 110 by way of Bluetooth protocols. When the handheld controller 120 is successfully paired with the right driving device 112 and the left driving device 113 simultaneously, the process proceeds to the step S120; otherwise, keep trying to establish the connection. In another embodiment, the handheld controller 120 may connect with the right driving device 112 and the left driving device 113 of the electric wheelchair 110 by way of other wireless technologies. Only when the handheld controller 120 is successfully paired with the right driving device 112 and the left driving device 113 simultaneously, the process proceeds to the step S120; otherwise, keep trying to establish the connection.

In addition, before the step S110, the handheld controller 120 may first finish the identity authentication. For example, the handheld controller 120 must be registered with a cloud server (not illustrated) in advance. Before the electric wheelchair 110 is operated, the handheld controller 120 may scan a barcode (such as two-dimensional bar code) on the electric wheelchair 110. After the cloud server (not illustrated) receives the identity information of the handheld controller 120, starting to verify the identity information of the handheld controller 120. Since the handheld controller 120 has finished the identity authentication, the process proceeds to the step S110 to establish the connection between the handheld controller 120 and the electric wheelchair 110 after the identity information of the handheld controller 120 is verified.

In the step S120, as illustrated in FIG. 1, the handheld controller 120, according to the posture of the handheld controller 120, outputs two corresponding control signals S1 to the right driving device 112 and the left driving device 113 of the electric wheelchair 110 by way of wireless technologies for controlling the motion of the wheelchair body 111. The control signal S1 transmitted to the right driving device 112 by the handheld controller 120 and the control signal S1 transmitted to the left driving device 113 by the handheld controller 120 may be the same type or different types. Compared with two driving devices being controlled by one control signal, the right driving device 112 and the left driving device 113 are controlled by two control signals S1 respectively in the present embodiment, and thus the electric wheelchair 110 has excellent controllability and can perform various motions.

The aforementioned “posture” means the display surface 120u of the handheld controller 120 is at a horizontal orientation, a vertical orientation or tilts toward, for example, forward, backward, rightward or rightward. In the present embodiment, the handheld controller 120 includes an acceleration sensor (G sensor) 123. When the handheld controller 120 changes posture itself, the acceleration component sensed by each axis (such as the X axis, the Y axis and the Z axis) of the acceleration sensor 123 also changes accordingly, and thus the second controller 122 of the handheld controller 120 outputs different (or corresponding) control signal to the electric wheelchair 110 for controlling the wheelchair body 111 to perform different (or corresponding) motion.

In an embodiment, a relationship between the acceleration component sensed by each axis of the acceleration sensor 123 and the motion performed by the electric wheelchair 110 may be stored in a database (not illustrated), the second controller 122 may determine the motion of the wheelchair according to the database by inquiring or calculating for outputting the corresponding control signals S1. Such database may be stored in the electric wheelchair 110, the handheld controller 120 or the cloud server. The aforementioned relationship between the acceleration component of each axis and the motion performed by the electric wheelchair 110 may be modified or set through an application program (APP), and the APP may be loaded by the second controller 122 of the handheld controller 120. In addition, the control method for the electric wheelchair 110 may be completed through the APP.

In step S130, as illustrated in FIG. 1, the right driving device 112 and the left driving device 113 of the electric wheelchair 110 may control the electric wheelchair 110 to perform the corresponding motion according to two control signals S1, such as stationary (or stop), a forward motion (for example, toward +y axis), a backward motion (for example, toward −y axis), a rightward motion (for example, around −z axis) or a leftward motion (for example, around +z axis). The x axis, y axis and z axis of FIG. 1 of the electric wheelchair 110 are vertical to each other, and a plane defined by X axis and Y axis of the handheld controller 120 is substantially vertical to the display surface 120u of the handheld controller 120.

In addition, in the step S120 and the step S130, if the electric wheelchair 110 disconnects with the handheld controller 120, the processor proceeds to the step S110 until the handheld controller 120 is successfully connected with the right driving device 112 and the left driving device 113 simultaneously. When the handheld controller 120 is successfully connected with the right driving device 112 and the left driving device 113 simultaneously, the processor proceeds to the steps S120 and S130.

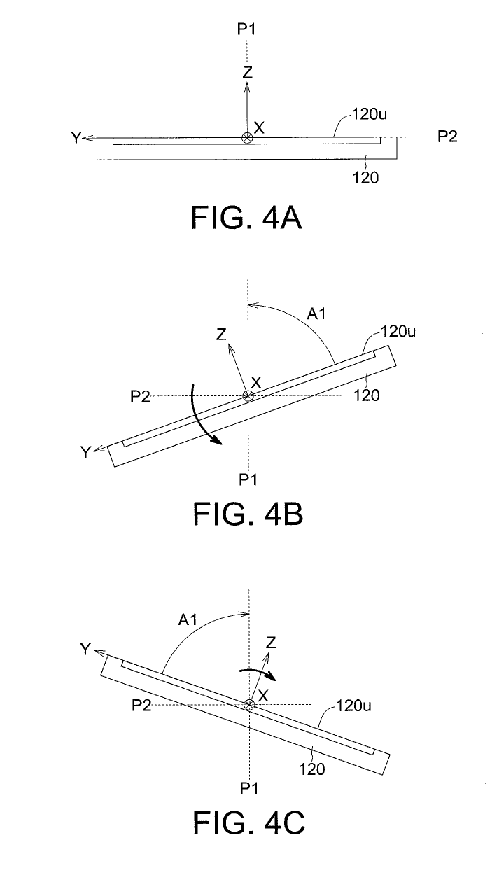

FIGS. 4A-4C illustrate diagrams of several control methods of the present embodiment according to the present disclosure. As illustrated in FIG. 4A, when the handheld controller 120 is at the horizontal orientation, for example, X-Y plane of the handheld controller 120 being at the horizontal orientation P2, the wheelchair body 111 is controlled to be stationary. As illustrated in FIG. 4B, when the handheld controller 120 tilts forward, e.g., around −X axis, the wheelchair body 111 advances, e.g., toward +y axis. As illustrated in FIG. 4C, when the handheld controller 120 tilts backward, e.g., around +X axis, the wheelchair body 111 backs, e.g., toward −y axis. In addition, the speed of the wheelchair body 111 advancing or backing is proportional to an inclination angle of the handheld controller 120. For example, the smaller the angle A1 included between the display surface 120u and the vertical orientation P1 is (more inclined), the faster the advancing speed or the backing speed of the wheelchair body 111 is; however, such exemplification is not meant to be limiting.

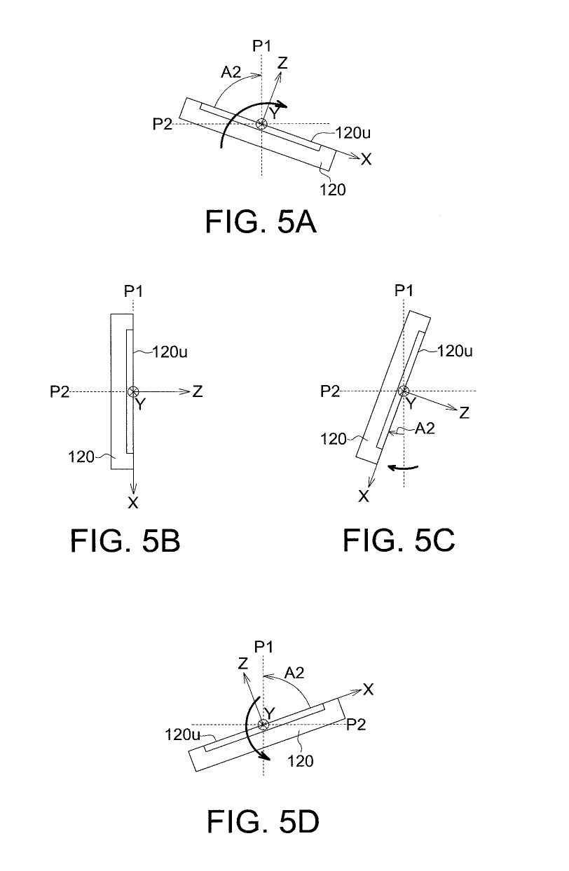

FIGS. 5A-5D illustrate diagrams of several control methods of the present embodiment according to the present disclosure. As illustrated in FIG. 5A, when the handheld controller 120 tilts rightward, e.g., around +Y axis, the wheelchair body 111 turns rightward, e.g., around −z axis. The smaller the angle A2 included between the display surface 120u and the vertical orientation P1 is (more inclined), the faster the speed of the wheelchair body 111 turning rightward is. As illustrated in FIG. 5B, when the handheld controller 120 rotates to be at the vertical orientation P1, e.g., the display surface 120u being at the vertical orientation P1, the speed of the wheelchair body 111 turning rightward is the fastest. As illustrated in FIG. 5C, when the handheld controller 120 of FIG. 5B continuous to rotate around +Y axis, the speed of the wheelchair body 111 starts to slow down. For example, the smaller the angle A2 included between the display surface 120u of FIG. 5C and the vertical orientation P1 is, the slower the speed of the wheelchair body 111 turning rightward is. When the display surface 120u of the handheld controller 120 is at the horizontal orientation and faces downward, the wheelchair body 111 is controlled to be stationary or stop. As illustrated in FIG. 5D, when the handheld controller 120 tilts leftward, e.g., around −Y axis, the wheelchair body 111 turns leftward, e.g., around +z axis. Similarly, the smaller the angle A2 included between the display surface 120u and the vertical orientation P1 is, the faster the speed of the wheelchair body 111 turning leftward is. The relationship between other left-tilting postures (for example, the display surface 120u is at the vertical orientation P1, or/and the display surface 120u rotates to be at the downward orientation) of the handheld controller 120 of FIG. 5D and the motions of the electric wheelchair 110 may be similar to that of the right-tilting postures of the handheld controller 120 and the motions of the electric wheelchair 110, and similarities are not repeated here.

As described above, the second controller 122 may determine whether the display surface 120u tilts from the horizontal orientation P2 to the vertical orientation P1 (as illustrated in FIGS. 5A to 5B). If the display surface 120u tilts from the horizontal orientation P2 to the vertical orientation P1, the smaller the angle A2 included between the display surface 120u and the vertical orientation P1 is, and the faster the motion speed of the wheelchair body 111 is. In addition, the second controller 122 may determine whether the display surface 120u tilts from the vertical orientation P1 to the horizontal orientation P2 (as illustrated in FIGS. 5B to 5C). If the display surface 120u tilts from the vertical orientation P1 to the horizontal orientation P2, the larger the angle A1 included between the display surface 120u and the vertical orientation P1 is, the slower the motion speed of the wheelchair body 111 is.

In an embodiment, the handheld controller 120 may tilt rightward and forward simultaneously for controlling the wheelchair body 111 turns rightward in advancing. In another embodiment, the handheld controller 120 may tilt leftward and forward simultaneously for controlling the wheelchair body 111 turns leftward in advancing.

In an embodiment, the handheld controller 120 may stop outputting the control signals S1 to the electric wheelchair 110 in response to a stop instruction for stopping controlling the wheelchair body 111. For example, the display surface 120u of the handheld controller 120 displays a virtual key. When the virtual key is triggered (the stop instruction is outputted) by the operator, it represents that the operator attempt to stop the motion of the wheelchair body 111. The handheld controller 120 responds to such stop instruction, outputting two stop operation signals to the right driving device 112 and the left driving device 113 of the electric wheelchair 110 respectively for making the electric wheelchair 110 to stop. The control signal S1 may be achieved by various types, and the stop operation signal herein may be one of the various types which is the signal for stopping the electric wheelchair 110. For example, when the right driving device 112 and the left driving device 113 receive the stop operation signals, stopping any motion performed by the electric wheelchair 110, or forcing the moving wheelchair body 111 to stop (for example, brake). Then, the handheld controller 120 do not output any control signal S1 to the electric wheelchair 110 unless the stop instruction is lifted, and accordingly, it can prevent the electric wheelchair 110 from performing unintended motion for ensuring the safety of the rider.

In another embodiment, the handheld controller 120 may restore the control signal S1 to be outputted to the electric wheelchair 110 in response to a restoration instruction. For example, when the virtual key is triggered again (it represents that the restoration instruction is outputted), it represents the operator attempts to restart the control for the wheelchair body 111. The handheld controller 120 responds to such restoration instruction, continuing outputting the control signals S1 to the electric wheelchair 110 for restarting the control for the wheelchair body 111. The aforementioned virtual key may be replaced by the physical key. In addition, during the control signals S1 not being outputted to the electric wheelchair 110, the connection between the handheld controller 120 and the electric wheelchair 110 may be maintained. In another embodiment, there is no connection between the handheld controller 120 and the electric wheelchair 110, and the connection between the handheld controller 120 and the electric wheelchair 110 is established (for example, in the step S110) when receiving the restoration instruction.

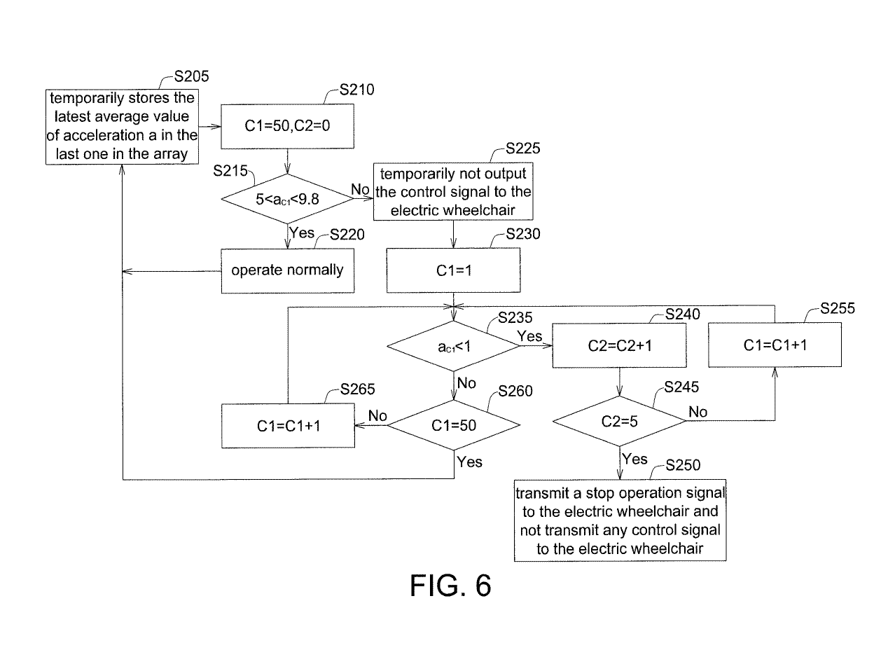

In an embodiment, the second controller 122 may detect whether the handheld controller 120 is at an abnormal state. If the handheld controller 120 is at the abnormal state, the handheld controller 120 may stop outputting any control signal S1 to the electric wheelchair 110 for preventing the handheld controller 120 from unintentionally controlling the electric wheelchair 110. The description will be stated below accompanied with FIG. 6.

FIG. 6 illustrates a flowchart of detecting whether the handheld controller 120 is at the abnormal state according to an embodiment of the present disclosure.

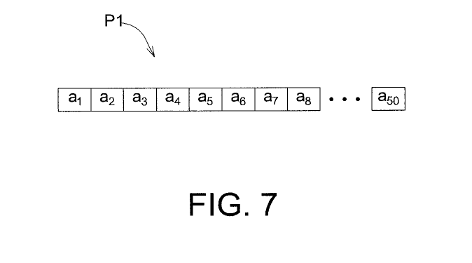

Firstly, the acceleration sensor 123 outputs current average value of acceleration a, wherein the average value of acceleration a is, for example, the square root of the square of the acceleration components of each axis of the acceleration sensor 123, or root mean square value of the acceleration components of each axis of the acceleration sensor 123. As illustrated in FIG. 7, FIG. 7 illustrates a diagram of an array P1 of the average value of accelerations a according to an embodiment of the present disclosure. The second controller 122 temporarily stores, in time sequence, the second designated number of the average values of accelerations a₁ to a₅₀ in the array P1, wherein the second designated number is, for example, 50, but may also be more or less.

Then, in the step S205, the second controller 122 forward pushes the average value of accelerations a₂ to a₅₀ other than the first one (count parameter C1=1) in the array P1. For example, the average value of acceleration aᵢ replaces the average value of acceleration aᵢ₋₁, wherein i is a positive integer ranging between 2 to 50, and the latest average value of acceleration a is temporarily stored in the last one of the array P1 to become the average value of acceleration a₅₀.

In the step S210, the second controller 122 sets the value of the count parameter C1 as the value of the second designated number, for example, 50, and an initial value of the drop parameter C2 is set to be zero.

In the step S215, the second controller 122 may determine whether the average value of acceleration a_{c1} (in this step, that is a₅₀) is equal to a predetermined value, for example, a value range of 5 to 9.8, or other value range, wherein the subscript C1 of symbol a represents the value of the count parameter C1. If the average value of acceleration a_{c1} is equal to the predetermined value, it represents the handheld controller 120 is at a normal operation, not at the abnormal state. Then, the processor proceeds to the step S220 of operating as in the normal mode, the handheld controller 120 continues to output the control signals S1 to the electric wheelchair 110 according to the posture of the handheld controller 120. Then, the process proceeds back to the step S205, the handheld controller 120 continues to determine the next new average value of acceleration a. The aforementioned abnormal state means the handheld controller 120 is falling or at abnormal shaking rather than falling. If the average value of acceleration a_{c1} is outside the predetermined value, it represents that the handheld controller 120 is in the abnormal state, and the process proceeds to the step S225. Then, the handheld controller 120 stops outputting any control signal S1 to the electric wheelchair 110 for preventing the handheld controller 120 from unintentionally controlling the electric wheelchair 110.

Then, in the step S230, the second controller 122 sets the value of the count parameter C1 as 1 for determining the average value of acceleration a₁ from the first one of the array P1 until all average value of accelerations a₁ to a₅₀ are determined and completed for determining whether the handheld controller 120 is falling.

In the step S235, the second controller 122 may determine whether the average value of accelerations a_{c1} is less than a predetermined value (for example, 1). If the average value of accelerations a_{c1} is less than the predetermined value, it represents that the handheld controller 120 is possibly falling, and the process proceeds to the step S240. If the average value of accelerations a_{c1} is not less than the predetermined value, the process proceeds to the step S260.

In the step S240, since the average value of accelerations a_{c1} is less than 1, the second controller 122 accumulates the value of the drop parameter C2. In the step S245, if the value of the drop parameter C2 is accumulated to be the first designated number, for example, 5, the handheld controller 120 is determined to be at the falling state, and thus the process proceeds to the step S250. In the step S250, the second controller 122 transmits the stop operation signals to the electric wheelchair 110, and the handheld controller 120 do not transmit any control signal S1 to the electric wheelchair 110 unless the handheld controller 120 receives aforementioned restoration instruction for preventing the handheld controller 120 from the electric wheelchair 110 unintentionally controlling the electric wheelchair 110 and for ensuring the safety of the occupant. In the step S245, if the value of the drop parameter C2 does not be accumulated to be the first designated number, the process proceeds to the step S255. In the step S255, the second controller 122 accumulates the value of the count parameter C1, and then continuing to determine the next average value of acceleration a_{c1} of the array P1.

In the step S260, the second controller 122 may determine whether the value of the count parameter C1 is the second designated number, that is, the second controller 122 determines whether the average value of acceleration a_{c1} is the last one of the array P1. If the average value of acceleration a_{c1} is the last one of the array P1, it represents all of the average values of accelerations a_{c1} of the array P1 have been determined, and the process proceeds back to the step S205 to determine the next latest average value of acceleration a. If the average value of acceleration a_{c1} is not the last one of the array P1, the process proceeds to the step S265 to accumulate the value of the count parameter C1, and then the process proceeds the step S235 to determine the next average value of acceleration a_{c1} of the array P1.

As described above, the second controller 122 may temporarily store the second designated number of the average values of accelerations a in the array P1 and then set the latest average value of acceleration as one member of the array P1. The second controller 122 may determine all average value of accelerations a of the array P1 for determining whether the handheld controller 120 is falling when the latest average value of acceleration a is within the abnormal value range (it represents the handheld controller 120 is in the abnormal state, and handheld controller 120 is possibly falling or over-shaken). When the number of the average values of accelerations a of the array P1 which is less than 1 is equal to or more than the first designated number, that the handheld controller 120 is determined to be falling.

As described above, in the operation method for the electric wheelchair in the present disclosure, the electric wheelchair is controlled to perform a corresponding motion through the change of the posture of the handheld controller. The term “posture” means the handheld controller or the display surface thereof is at the horizontal orientation, the vertical orientation and tilts toward one side, such as toward forward direction, backward direction, leftward direction and/or rightward direction, and “the corresponding motion” means advancing motion, backward motion, left-turning motion and/or right-turning motion. In addition, the handheld controller may control the corresponding motion speed of the electric wheelchair through the different postures of the handheld controller. The relationship between the posture of the handheld controller and the corresponding motion performed by the electric wheelchair are not limited to aforementioned embodiments, and any one of the aforementioned postures of the handheld controller may control the electric wheelchair to perform any one of the aforementioned motions. In addition, the relationship between the postures of the handheld controller and the motions performed by the electric wheelchair may be changed or set through the APP.

It will be apparent to those skilled in the art that various modifications and variations can be made to the structure of the disclosed embodiments without departing from the scope or spirit of the disclosure. In view of the foregoing, it is intended that the disclosure cover modifications and variations of the present disclosure provided they fall within the scope of the following claims and their equivalents.

What is claimed is:

1. A control method for an electric wheelchair, comprising:
outputting a plurality of control signals to a plurality of driving devices of the electric wheelchair respectively by way of wireless technologies according to a posture of a handheld controller, wherein the number of the control signals is equal to the number of the driving devices;
controlling the electric wheelchair to perform a corresponding motion by the driving device of the electric wheelchair in accordance with the control signals;
detecting whether the handheld controller is at an abnormal state; and
if the handheld controller is at the abnormal state, temporarily stopping outputting the control signals to the electric wheelchair.

2. The control method according to claim 1, further comprising:
determining whether the handheld controller tilts from a horizontal orientation to a vertical orientation; and
if the handheld controller tilts from the horizontal orientation to the vertical orientation, the smaller the angle included between the handheld controller and the vertical orientation is, the faster the speed of the corresponding motion of the electric wheelchair is.

3. The control method according to claim 1, further comprising:
when the handheld controller is at a vertical orientation, the speed of the corresponding motion of the electric wheelchair is the fastest.

4. The control method according to claim 1, further comprising:
determining whether the handheld controller tilts from a vertical orientation to a horizontal orientation; and
if the handheld controller tilts from the vertical orientation to the horizontal orientation, the larger the angle included between the handheld controller and the vertical orientation is, the slower the speed of the corresponding motion of the electric wheelchair is.

5. The control method according to claim 1, wherein the handheld controller has an X axis, a Y axis and a Z axis which are vertical to each other, and the posture is how the handheld controller rotates around at least one of the X axis, the Y axis and the Z axis.

6. The control method according to claim 1, further comprising:
in response to a stop instruction, stopping outputting the control signals to the electric wheelchair.

7. The control method according to claim 6, wherein after the step of in response to the stop instruction, stopping outputting the control signals to the electric wheelchair, the control method further comprises:
in response to a restoration instruction, restoring outputting the control signals to the electric wheelchair.

8. The control method according to claim 1, wherein the step of detecting whether the handheld controller is at the abnormal state comprises:
calculating an average value of acceleration of the handheld controller;
determining whether the average value of acceleration is equal to a predetermined value; and
if the average value of acceleration is not equal to the predetermined value, determining the handheld controller is at the abnormal state.

9. The control method according to claim 1, wherein the step of detecting whether the handheld controller is at the abnormal state comprises:
calculating a plurality of average values of accelerations of the handheld controller;
determining whether the number of the average values of accelerations which are not equal to a predetermined value is more than a designated number; and
if the number of the average values of accelerations which are not equal to the predetermined value is more than the designated number, determining the handheld controller is at a dropping state.

10. The control method according to claim 9, wherein the step of detecting whether the handheld controller is at the abnormal state further comprises:
once any of the average values of accelerations is determined not equal to the predetermined value, temporarily stopping outputting the control signals to the electric wheelchair; and
if the number of the average values of accelerations which are not equal to the predetermined value is not more than the designated number, restoring outputting the control signals to the electric wheelchair.

11. The control method according to claim 9, wherein the step of detecting whether the handheld controller is at the abnormal state further comprises:
once any of the average values of accelerations is determined not equal to the predetermined value, stopping outputting the control signals to the electric wheelchair; and
before receiving a restoration instruction, not outputting the control signals to the electric wheelchair.

12. A control system for an electric wheelchair, comprising:
a handheld controller, comprising:
an acceleration sensor configured to output a corresponding acceleration information according to a posture of the handheld controller; and
a controller configured to output a plurality of control signals according to the acceleration information; and
an electric wheelchair, comprising:
a wheelchair body comprising a plurality of wheels; and
a plurality of driving devices each configured to detachably dispose on the wheels of the wheelchair body for controlling the wheels to rotate according to the control signals respectively to perform a corresponding motion, wherein the number of the control signals, the number of the driving devices and the number of the wheels are equal;
wherein the handheld controller is further configured to:
detect whether the handheld controller is at an abnormal state according to the acceleration information; and
if the handheld controller is at the abnormal state, respectively output a plurality of stop operation signals to the driving devices and then stop outputting the control signals to the electric wheelchair.

13. An electric wheelchair, comprising:
a wheelchair body comprising a plurality of wheels; and
a plurality of driving devices each detachably disposed on the wheels of the wheelchair body,
wherein the driving devices are configured to control the wheelchair body to perform a corresponding motion according to a plurality of control signals from a handheld controller, and the control signals are determined by a posture of the handheld controller; wherein the number of the control signals, the number of the driving devices and the number of the wheels are equal, and the driving devices are configured to, in response to a plurality of stop operation signals, stop driving the wheels.
